(19) United States
(12) Patent Application Publication
(10) Pub. No.: US 2015/0007951 A1
(43) Pub. Date: Jan. 8, 2015

(54) METHOD FOR RECOVERY OF MOLYBDATE IN A MOLYBDATE-CATALYSED DELIGNIFICATION OF PULP WITH HYDROGEN PEROXIDE

(71) Applicant: Evonik Industries AG, Essen (DE)

(72) Inventors: Thomas Dietz, Haibach (DE); Bernd Hopf, Kahl (DE); Ralf Grimmer, Freigericht (DE)

(73) Assignee: Evonik Industries AG, Essen (DE)

(21) Appl. No.: 14/373,362

(22) PCT Filed: Dec. 19, 2012
(86) PCT No.: PCT/EP2012/076249

§ 371 Date: Jul. 20, 2014

(30) Foreign Application Priority Data
Jan. 24, 2012 (DE) 10 2012 200 990.6

(51) Int. Cl. D21C 11/00; D21C 9/18; B01J 23/28

(52) U.S. Cl. CPC D21C 11/005; B01J 23/28; D21C 9/18
USPC 162/45

(57) ABSTRACT

In a delignification of pulp with hydrogen peroxide catalyzed by molybdate, molybdate can be recovered by contacting the molybdate-containing aqueous solution at a pH in the range from 2 to 7 with a carrier material comprising a sheet silicate been ion-exchanged with a quaternary ammonium salt and subsequent flotation without a surfactant having to be added for flotation.

The invention relates to a process for recovering molybdate in a molybdate-catalyzed delignification of pulp with hydrogen peroxide.

The bleaching of pulp is usually carried out with hydrogen peroxide in an alkaline medium since free radicals which lead to undesirable secondary reactions, e.g. the degradation of cellulose, are formed in an acidic medium at elevated temperature. However, when a suitable catalyst is used, delignification and bleaching with hydrogen peroxide is also possible under acidic conditions.

U.S. Pat. No. 4,427,490 describes delignification and bleaching of kraft pulp with hydrogen peroxide in an acidic medium, catalyzed by sodium tungstate or sodium molybdate.

WO 2009/133053 describes a process for recovering molybdate or tungstate from an aqueous solution, which is suitable for recovering molybdate or tungstate in a molybdate or tungstate-catalyzed delignification of pulp with hydrogen peroxide. In this process, molybdate or tungstate is adsorbed on a water-insoluble, cationized inorganic carrier material at a pH in the range from 2 to 6 and desorbed again from the carrier material into an aqueous solution at a pH in the range from 6 to 14. Separation of the carrier material after the adsorption and after the desorption is carried out in each case by sedimentation, filtration or centrifugation.

N. Sameer et al., Ind. Eng. Chem. Res. 47 (2008) 428-433 describe a process for recovering molybdate in a molybdate-catalyzed delignification of pulp with hydrogen peroxide, in which, in order to separate molybdate, a sparingly soluble molybdate salt is precipitated with dodecylamine or cetyltrimethylammonium bromide at a pH of from 3 to 4.5 and the precipitated salt is filtered and redissolved in dilute sodium hydroxide solution and dodecylamine or cetyltrimethylammonium salt liberated during dissolution of the salt are extracted from the resulting solution with isobutanol. Flotation of the salt precipitated with dodecylamine was examined as an alternative to filtration, but this allowed a recovery of only 83% of the molybdate.

It has now surprisingly been found that, in the recovery of molybdate as described in WO 2009/133053 from solutions obtained in the delignification of pulp, using a carrier material comprising a sheet silicate ion-exchanged with a quaternary ammonium salt, the carrier material can be separated by flotation both in an acidic pH range and in an alkaline pH range without the need of adding a surfactant.

The invention accordingly provides a process for recovering molybdate in a molybdate-catalyzed delignification of pulp with hydrogen peroxide, comprising the steps
a) delignification of pulp in an aqueous mixture containing from 0.1 to 5% by weight of hydrogen peroxide and from 10 to 2000 ppm of molybdenum in the form of molybdate, in each case based on the mass of dry pulp, at a temperature of from 30 to 100° C. and a pH in the range from 1 to 7,
b) separation of the delignified pulp from the mixture obtained in step a) to give an aqueous solution,
c) contacting the aqueous solution obtained in step b) at a pH in the range from 2 to 7 with a carrier material comprising a sheet silicate ion-exchanged with a quaternary ammonium salt to give a mixture of molybdate loaded carrier material and an aqueous solution depleted in molybdate,
d) separation of molybdate loaded carrier material from the mixture obtained in step c) by flotation to give an aqueous solution depleted in molybdate,
e) contacting the molybdate loaded carrier material with an aqueous solution at a pH in the range from 7 to 14 to give a mixture of carrier material depleted in molybdate and an aqueous solution loaded with molybdate,
f) separation of carrier material depleted in molybdate from the mixture obtained in step e) to give an aqueous solution loaded with molybdate and
g) recycling the aqueous solution loaded with molybdate obtained in step f) to step a).

For the purposes of the invention, the term molybdate encompasses both mononuclear molybdate MoO₄²⁻ and polynuclear molybdates such as Mo₇O₂₄⁶⁻ and Mo₈O₂₆⁴⁻ and heteroatom-containing polynuclear molybdates such as PMo₁₂O₄₀³⁻ and SiMo₁₂O₄₀³⁻.

The process of the invention comprises, in a step a), a delignification of pulp in which pulp is reacted in an aqueous mixture comprising hydrogen peroxide and molybdenum in the form of molybdate as catalyst.

In the delignification of pulp with addition of molybdate as catalyst, from 0.1 to 5% by weight, preferably from 0.2 to 4% by weight and particularly preferably from 0.3 to 1% by weight, of hydrogen peroxide, based on the mass of dry pulp, is used. Molybdate is used as catalyst in an amount of from 10 to 2000 ppm, preferably from 30 to 700 ppm and particularly preferably from 50 to 500 ppm, of molybdenum, based on the mass of dry pulp. Selection of the amounts of hydrogen peroxide and molybdate in these ranges achieves effective delignification and bleaching of the pulp and gives a pulp having a reduced yellowing tendency.

The delignification of cellulose with addition of molybdate as catalyst is carried out at a temperature of from 30 to 100° C., preferably from 60 to 95° C. and particularly preferably from 75 to 95° C., with the pH being selected in the range from 1 to 7, preferably from 2 to 6 and particularly preferably from 2.5 to 5.5. The choice of the reaction conditions brings about rapid and effective delignification and bleaching of the pulp. In addition, the delignification with addition of molybdate under these reaction conditions can be combined with further process steps for delignification and/or bleaching with only a small additional consumption of energy and/or chemicals for setting the temperature and/or pH.

In the delignification in step a), chlorine dioxide can be added in addition to hydrogen peroxide. Chlorine dioxide can be used together with hydrogen peroxide. However, preference is given to carrying out delignification in a bleaching stage firstly with chlorine dioxide and, after reaction of more than 90% of the chlorine dioxide employed, with hydrogen peroxide and molybdate as catalyst, as described in EP 2 345 760 A1.

In a step b) following the delignification, the delignified pulp is separated from the mixture obtained in step a) to give an aqueous solution. The separation is preferably effected by filtration, in particular by filtration using a drum filter, a filter press or a screw press. Suitable filtration methods are known to those skilled in the field of pulp bleaching.

In a subsequent step c), the aqueous solution obtained in step b) is brought into contact at a pH in the range from 2 to 7 with a carrier material comprising a sheet silicate ion-exchanged with a quaternary ammonium salt, giving a mixture of molybdate loaded carrier material and an aqueous solution depleted in molybdate.

In step c), the contacting of the molybdate-containing aqueous solution with the carrier material is carried out at a pH in the range from 2 to 7, preferably in the range from 3 to 6, particularly preferably in the range from 3.5 to 5. Setting a pH in these ranges allows for virtually complete recovery of molybdate from the aqueous solution with a low consumption of pH-regulating agents. In the contacting operation, the carrier material is preferably distributed in the molybdate-containing aqueous solution by means of a stirrer or a disperser. Contacting can be carried out at any desired temperature, with temperatures in the range from 0 to 100° C. being suitable. In step c), the carrier material is preferably used in an amount of from 10 to 1000 parts by weight of carrier material per part by weight of molybdenum. Particular preference is given to using from 50 to 500 parts by weight and in particular from 100 to 300 parts by weight of carrier material per part by weight of molybdenum.

The carrier material used in step c) of the process of the invention comprises a sheet silicate ion-exchanged with a quaternary ammonium salt. The carrier material preferably comprises more than 30% by weight, preferably more than 50% by weight, of sheet silicate ion-exchanged with a quaternary ammonium salt.

Suitable sheet silicates are, for example, kaolins, smectites, illites, bentonites (montmorillonites), hectorites, pyrophillites, attapulgites, sepiolites and laponites, preferably bentonites, hectorites and attapulgites, particularly preferably bentonite.

The quaternary ammonium salt used preferably has at least one nonpolar alkyl radical having from 6 to 24 carbon atoms, particularly preferably from 10 to 22 carbon atoms, in order to prevent leaching of the quaternary ammonium ions from the support in an acidic medium and make flotation without addition of surfactants possible.

Bentonites, hectorites and attapulgites ion-exchanged with quaternary ammonium salts are commercially available: quaternium-18 bentonite as Bentone 34 from Rheox Corp. and as Claytone 34, Claytone 40 and Claytone XL from Southern Clay; stearalkonium bentonite as Tixogel LG from United Catalysts, as Bentone SD-2 from Elementis Specialties and as Claytone AF and Claytone APA from Southern Clay; quaternium-18/benzalkonium bentonite as Claytone GR, Claytone HT and Claytone PS from Southern Clay; quaternium-18 hectorites as Bentone 38 from Rheox Corp.; hydrogenated ditalloylbenzalkonium hectorite as Bentone SD-3 from Rheox Corp.; stearalkonium hectorite as Bentone 27 from Rheox Corp.; and cationized attapulgite as Vistrol 1265 from Cimbar. These sheet silicates ion-exchanged with a quaternary ammonium salt can be used in the process of the invention either as powder or in the form of the commercially available dispersions in an oil or an organic solvent.

Apart from the commercial bentonites, hectorites and attapulgites ion-exchanged with tetraalkylammonium ions, it is also possible to use the corresponding materials ion-exchanged with quaternized alkanolamine fatty acid esters, in particular bentonite ion-exchanged with dimethyldiethanolammonium monofatty acid and difatty acid esters or with methyltriethanolammonium monofatty acid, difatty acid and trifatty acid esters. Preference is given to using corresponding esters with saturated fatty acids, in particular saturated fatty acids having from 12 to 18 carbon atoms.

In a subsequent step d), the molybdate loaded carrier material is separated by flotation from the mixture obtained in step c) and an aqueous solution depleted in molybdate is obtained.

For the separation by flotation, all flotation methods known to those skilled in the art can be used, for example induced gas flotation or dissolved gas flotation. Preference is given to using induced gas flotation in which a gas is passed through the mixture from step c). Particular preference is given to passing air through the mixture obtained in step c) to effect flotation. Flotation can be carried out in flotation cells known from the prior art. One or more flotation stages connected in series can be used for separating the molybdate loaded carrier material. After the flotation, the solution depleted in molybdate is preferably additionally filtered in order to separate the molybdate loaded carrier material as completely as possible.

Surprisingly, the molybdate loaded carrier material can be separated readily and to a large proportion by flotation without addition of a foam-forming surfactant. Flotation auxiliaries known to those skilled in the art, for example flocculants, foam-forming surfactants or antifoams, can additionally be added in the flotation to regulate the amount of foam and to improve the separation.

Compared to the separation by sedimentation, filtration or centrifugation known from WO 2009/133053, the separation of the molybdate loaded carrier material by flotation has the advantage that it can be carried out using smaller and simpler apparatuses and requires less energy for the separation. With a combination of flotation and subsequent filtration, a high recovery of the molybdate loaded carrier material can be achieved with a low energy consumption.

In the separation by flotation, the molybdate loaded carrier material is separated in the form of an aqueous foam, which is also referred to as flotate. This aqueous foam is preferably converted into a concentrated aqueous suspension and the resulting aqueous suspension is filtered in order to separate the molybdate loaded carrier material from water present in the flotate. The foam can be converted into a concentrated aqueous suspension by allowing to stand or by another method known to those skilled in the art for flotation processes. In the filtration of the flotate, a comparatively small volume stream is filtered compared to filtration of the total mixture as described in WO 2009/133053, so that it is possible to use a much smaller filtration plant which has a lower energy consumption.

Water-insoluble filter aids can be added during or after the flotation to improve a filtration following flotation. Suitable as water-insoluble filter aids are the filter aids known from the prior art, which can be synthetic or natural, organic or inorganic in nature. A suitable inorganic filter aid is, for example, the silica gel which can be obtained under the trade name Celite 503 from Merck. A suitable natural organic filter aid is, for example, cellulose which can be obtained under the trade name Jelucel HM 200 from Jelu.

The carrier material which is loaded with molybdate in step c) and separated in step d) is brought into contact with an aqueous solution at a pH in the range from 7 to 14 in a step e), as a result of which molybdate is leached from the carrier material and a mixture of carrier material depleted in molybdate and an aqueous solution loaded with molybdate is obtained.

The pH is here preferably selected in the range from 7 to 12 and particularly preferably in the range from 8 to 11. Setting a pH in these ranges allows for virtually complete leaching of molybdate from the carrier material with a low consumption of pH-regulating agents. In the contacting operation, the molybdate loaded carrier material is preferably dispersed in the aqueous solution with a stirrer or a disperser. Contacting can be carried out at any desired temperature, with temperatures in the range from 0 to 100° C. being suitable.

In a subsequent step f), the carrier material depleted in molybdate is separated from the aqueous solution loaded with molybdate. The separation can be carried out by all solid-liquid separation processes known to those skilled in the art, for example by sedimentation, filtration or centrifugation. In a preferred embodiment, the carrier material depleted in molybdate is separated by filtration. In an alternative preferred embodiment, the carrier material depleted in molybdate is separated by flotation. The flotation can be carried out as described for step d). Surprisingly, the carrier material depleted in molybdate can be separated readily and to a large proportion by flotation without addition of a foam-forming surfactant even at a pH in the alkaline range.

The separated carrier material depleted in molybdate can additionally be washed with an aqueous solution having a pH in the range from 6 to 14 in order to complete the leaching of molybdate from the carrier material. The washing liquid resulting from washing is preferably combined with the aqueous solution loaded with molybdate.

The aqueous solution loaded with molybdate obtained in step f) is subsequently recycled to step a).

The carrier material depleted in molybdate which has been separated in step f) is preferably recycled to step c) of the process and reused for recovering molybdate.

The following examples illustrate the process claimed, but without restricting the subject matter of the invention.

### EXAMPLE

831.3 g of eucalyptus pulp, corresponding to 200 g of absolutely dry pulp, having a kappa number of 13.0, a brightness of 54.0% ISO and a yellow value of 30.3 were brought to a solids content of 10% by weight with water, 0.5% by weight of hydrogen peroxide and 500 ppm of molybdenum in the form of sodium molybdate (based on absolutely dry pulp), and the pH was set with sulphuric acid to pH 3.0. The mixture was heated in a plastic bag for 120 minutes at 90° C. on a waterbath. Water was then added so as to give a suspension having a solids content of 4% by weight, and the pulp was filtered on a suction filter provided with filter paper. The treated pulp had a kappa number of 5.2, a brightness of 53.0% ISO and a yellow value of 31.1. The filtrate obtained had a pH of 3.7. The filtrate contained 19 ppm of molybdenum, corresponding to 95% of the amount used.

In a 1000 ml glass beaker, 6.0 g of cationically modified bentonite BENTONE® SD-2 (Elementis Specialties) were added to 600 g of the filtrate which still had a temperature of 70° C. and the mixture was stirred for 2 minutes with a magnetic stirrer motor. The suspension was then transferred to a Büchner funnel having a glass frit plate (diameter 130 mm, height 98 mm, glass frit type G1 with a pore size of 100-160 μm) which was placed with a pierced rubber stopper onto a suction flask, by means of which 2.2 l/min of air was passed through the glass frit plate via the suction port. A light-brown foam was formed by flotation at the surface of the liquid in the Büchner funnel and this was skimmed with a spoon and transferred to a beaker. After flotation for 2 minutes, the introduction of air was stopped, after which the liquid flowed down into the suction flask within a few seconds. The liquid contained 1.0 ppm of molybdenum, corresponding to a molybdenum removal of 95%. The collected flotation foam was filtered via a suction filter provided with filter paper and the filter cake was subsequently sucked dry.

A 2.4 g portion of the air-dried filter cake was suspended in 83 g of water and heated to 70° C. while stirring on a hotplate having a magnetic stirrer motor. A pH of 8 was then set by addition of sodium hydroxide and the mixture was stirred for a further 2 minutes. The suspension was subsequently subjected to flotation in a Büchner funnel as described in the preceding paragraph. A light-brown foam was formed at the surface of the liquid and this was skimmed with a spoon and transferred to a beaker. After flotation for 2 minutes, the introduction of air was stopped, after which the liquid flowed down into the suction flask within a few seconds. The collected flotation foam was filtered via a suction filter provided with filter paper and the filter cake was washed with two portions of 8 g each of water having a pH of 8 and subsequently sucked dry. The wash water was combined with the flotation water and the flotation foam filtrate and the molybdenum content was determined. The molybdenum content indicates a recovery of molybdenum of 88%, based on the amount of molybdenum used for delignification.

A further 2.4 g portion of the air-dried filter cake was suspended in 39 g of water and heated to 70° C. while stirring on a hotplate having a magnetic stirrer motor. A pH of 8 was then set by addition of sodium hydroxide and the mixture was stirred for a further 15 minutes. The suspension was subsequently filtered via a suction filter provided with filter paper and the filter cake was washed with two portions of 4 g each of water having a pH of 8 and subsequently sucked dry. The wash water was combined with the filtrate and the molybdenum content was determined. The molybdenum content indicates a recovery of molybdenum of 90%, based on the amount of molybdenum used for delignification.

1-16. (canceled)

17. A process for recovering molybdate in a molybdate-catalyzed delignification of pulp with hydrogen peroxide, comprising the steps:
a) delignifying pulp in an aqueous mixture containing from 0.1 to 5% by weight of hydrogen peroxide and from 10 to 2000 ppm of molybdenum in the form of molybdate, in each case based on the mass of dry pulp, at a temperature of from 30 to 100° C. and a pH in the range from 1 to 7;
b) separating the delignified pulp from the mixture obtained in step a) to give an aqueous solution;
c) contacting the aqueous solution obtained in step b) at a pH in the range from 2 to 7 with a carrier material comprising a sheet silicate ion-exchanged with a quaternary ammonium salt to give a mixture of molybdate loaded carrier material and an aqueous solution depleted in molybdate;
d) separating molybdate loaded carrier material from the mixture obtained in step c) by flotation to give an aqueous solution depleted in molybdate;
e) contacting the molybdate loaded carrier material with an aqueous solution at a pH in the range from 7 to 14 to give a mixture of carrier material depleted in molybdate and an aqueous solution loaded with molybdate;
f) separating carrier material depleted in molybdate from the mixture obtained in step e) to give an aqueous solution loaded with molybdate; and
g) recycling the aqueous solution loaded with molybdate obtained in step f) to step a).

18. The process of claim 17, wherein, in the flotation in step d), air is passed through the mixture obtained in step c).

19. The process of claim 17, wherein, in step d), the aqueous solution depleted in molybdate is additionally filtered after flotation.

20. The process of claim 17, wherein, in step d), molybdate loaded carrier material is separated as aqueous foam by flotation, the aqueous foam is converted into a concentrated aqueous suspension and the concentrated aqueous suspension is filtered.

21. The process of claim 17, wherein, in step f), carrier material depleted in molybdate is separated by flotation.

22. The process of claim 17, wherein the carrier material comprises more than 30% by weight of sheet silicate ion-exchanged with a quaternary ammonium salt.

23. The process of claim 17, wherein the sheet silicate is selected from the group consisting of bentonite, hectorite and attapulgite.

24. The process of claim 17, wherein the quaternary ammonium salt has at least one nonpolar alkyl radical having from 6 to 24 carbon atoms.

25. The process of claim 17, wherein molybdate depleted carrier material which has been separated in step f) is recycled to step c).

26. The process of claim 17, wherein, in step a), the aqueous mixture contains from 0.2 to 4% by weight of hydrogen peroxide, based on the mass of dry pulp.

27. The process of claim 17, wherein, in step a), the aqueous mixture contains from 30 to 700 ppm of molybdenum in the form of molybdate, based on the mass of dry pulp.

28. The process of claim 17, wherein, in step a), the delignification of the pulp is carried out at a temperature of from 60 to 95° C.

29. The process of claim 17, wherein, in step a), the delignification of the pulp is carried out at a pH of from 2 to 6.

30. The process of claim 17, wherein, in step c), the pH is in the range from 3 to 6.

31. The process of claim 17, wherein, in step e), the pH is in the range from 7 to 12.

32. The process of claim 17, wherein, in step c), from 10 to 1000 parts by weight of carrier material per part by weight of molybdenum are used.
